(19) United States
(12) Patent Application Publication
(10) Pub. No.: US 2007/0272168 A1
(43) Pub. Date: Nov. 29, 2007

(54) WEIGHTED LARIAT

(76) Inventors: Sandy H. Stephens, Prosper, TX (US); Anthony W. Benishek, Southlake, TX (US)

Correspondence Address: Michael A. O'Neil;Michael A. O'Neil, P.C., Suite 820, 5949 Sherry Lane, Dallas, TX, 75225, US

(21) Appl. No.: 11/839,069

(22) Filed: Aug. 15, 2007

Related U.S. Application Data
(63) Continuation-in-part of application No. 11/538,469, filed on Oct. 4, 2006.
(60) Provisional application No. 60/729,550, filed on Oct. 24, 2005.

(51) Int. Cl. A01K 15/04

(52) U.S. Cl. 119/805

(57) ABSTRACT

The present invention comprises a weighted lariat that improves ropers' chances of catching animals at which the lariat is thrown, particularly in competitive roping events. Weight is added to the tip of the loop by covering a portion of the loop with an elastomer such as natural rubber, synthetic rubber, and the like.

### CROSS-REFERENCE TO RELATED APPLICATIONS

This application is a continuation-in-part patent application to application Ser. No. 11/538,469 filed Oct. 4, 2006, currently pending, the entire contents of which are incorporated herein by reference; which claims priority of provisional application Ser. No. 60/729,550 filed Oct. 24, 2005, currently pending, the entire contents of which are incorporated herein by reference.

### TECHNICAL FIELD

This invention relates to lariats for use in competitive roping contests wherein the lariats comprise a loop having a weighted portion to facilitate improved action when the lariats are thrown by ropers.

### BACKGROUND AND SUMMARY OF THE INVENTION

Lariats are well known in the art, and have changed little since their initial use in ranching over a century ago. Lariats are used for various purpose. Historically, the most prominent use has been to catch animals such as cattle so that they may be marked or medically treated, but lariats are also one of the most important pieces of equipment used in competitive roping contests.

Lariats comprise a length of rope made of natural materials such as rawhide and hemp, and synthetic materials such as nylon, polyester, or other like materials. The length of rope has a knot called a honda at one end through which the rest of the rope extends to form a loop, the end of the rope opposite the honda being referred to as a tail. The tip of the honda is typically covered by a burner, which is a piece of rawhide that is sewn or plastic that is shrunk onto the honda to decrease friction and improve the performance and longevity of the rope. The majority of the length of rope extends through the honda and is typically wound by ropers into coils for ease of holding, carrying, and releasing the loop. In order to swing and throw the loop at an animal the roper desires to catch the roper grabs a portion of the loop and a portion of the rope between the honda and the coils. The portion between the honda and the roper's hand where the rope is grabbed is referred to as the spoke. The portion of the loop furthest from the roper's hand when the roper swings the loop is referred to as the tip.

Lariats are widely used in competitive, timed cattle-roping contests such as team roping, steer roping, and calf roping. Team roping includes two participants, both on horseback and each having a lariat, as well as a steer that is positioned between them. The timing of the event begins when the steer is motivated to run down the center of the arena, and the two mounted participants chase the steer on either side. The participant on the left of the steer, referred to as the header, attempts to rope the head or horns of the steer, and if successful the header wraps the lariat around the saddle horn and reins his horse to guide the steer to the left. The participant on the right, referred to as the heeler, then attempts to rope the back two legs of the steer. If successful, the heeler wraps the rope around the saddle horn thus stopping the steer. Once both the header and the heeler are successful and their horses are facing each other the timing is stopped. Generally, the fastest team to complete this task wins the competition. In most competitions, highly-competitive teams will complete the task in four to ten seconds.

Steer roping includes just one participant who is mounted on horseback with a lariat, as well as a steer that is positioned in a chute. Again, the timing of the event begins when the steer is motivated to run down the arena, and the mounted participant chases the steer until the participant is able to rope the steer about the horns. The participant then lays the rope over the right side of the steer and reigns the horse to the left, thus causing the steer to lay on its side. The roper then dismounts, runs up to the steer, and ties three of the steer's legs together so that it cannot get up and move away, at which time the timing is stopped. Competitive steer ropers complete this task in 12 to 20 seconds.

Calf roping includes just one participant who is mounted on horseback with a lariat, as well as a calf that is positioned in a chute to the participant's left or right. Again, the timing of the event begins when the calf is motivated to run down the center of the arena, and the mounted participant chases the calf until the participant is able to rope the calf about the neck or other part of the calf's body. The participant then dismounts and runs up to the calf, throws the calf on its side, and ties three of the calf's legs together so that it cannot get up and move away, whereupon timing is stopped. Competitive calf ropers also complete this task in six to ten seconds.

As the time to complete the tasks in competitive cattle-roping is so short the performance of the equipment used by the participants, and in particular lariats, is of upmost importance. When headers or steer ropers throw lariats at an animal the intention is that the loop will pass over and about the animal's horns or head, and the lead end of the loop, referred to as a tip, will continue to rotate in the direction of the ropers' throw so that the tip continues to the side or the rear of the animal's horns or head. As the tip rotates about the animal's head it is hoped that the tip will flip or curl over itself forming the loop into something resembling a figure eight. This action is referred to by headers as curl. Curl is desired because it keens the loop taught about the animal's neck or horns until the header is able to pull the slack out of the line and tighten the loop around the necks or horns.

When heelers throw loops at an animal the intention is that the animal will jump into the loop and that the loop will wrap around the animal's back legs. In order to get the lariat to wrap around the legs, the tip of the lariat must travel completely underneath the animal, referred to in the art as follow through, from one side of the animal to the other. Follow through is critical in order that both of the animal's rear legs are captured.

As previously explained, the basic components of lariats have changed little over time. The improvement that the present invention provides is adding weight to the tip of the loop by covering that portion of a lariat with shrink-wrap tubing such as polyolefin or neoprene to improve the action the loop when thrown. Additional weight may be added by wrapping elongated metal wires around the lariat. If used the metal wires are placed in the grooves of the rope between the wound or twisted strands. The weight that is added to the tip of the lariat is varied depending on the requirements of the roper that is using it, as well as the uses to which the lariat will be put, by adding additional or longer lengths of tubing and/or wire.

For headers and steer ropers the increased action in the loop is caused by the fact that the increased weight in the loop creates more momentum and thus a greater tendency to continue its rotation around the horns or neck of the animal and to curl. As explained above, this increases the chance that the roper, for example, a header or a calf roper will catch the animal. For heelers the increased weight of the tip of the loop creates additional momentum to get the desired follow through necessary to catch both back legs. For calf ropers the increased weight of the tip allows the roper to throw the rope further and control the location of the tip of the loop, as well as to get more action to prevent the calf from running through the loop.

As these competitive cattle-roping events take place while the participants are running down the arena at approximately 30 miles per hour, and since many events occur in outdoor arenas where wind conditions may vary, the increased weight of the tip gives the roper greater control of the swing and delivery of the loop.

The present invention contains substantial improvements cover the prior art, and in particular over U.S. Pat. No. 4,648,352, issued to Smith on Mar. 10, 1987, which discloses a weighted heeling rope. Smith discloses adding weight to the loop either by covering a portion of the loop with leather stripping or molded plastic, by inserting a weighted member along the centerline of the lariat, or by wrapping additional strands of rope or twine around the lariat.

One embodiment of the present invention comprises covering a portion of the lariat with a length of shrink-wrap tubing, and in some cases fitting lengths of metal wire into the grooves between the strands comprising the lariat. The variability of the size and number of pieces of metal wire allows the lariat to be tailored to a specific user, and comprises a substantial improvement over the prior art. Further, the use of the pieces of wire and thin, low-friction shrink-wrap tubing allows the thickness of the tip of the loop to be only minimally increased reducing the chances of the lariat sticking when the slack is pulled out of the line, which is another substantial improvement over the prior art. Further, because the useful life of a lariat depends on the wear of the twines of the rope, the low-friction shrink-wrap tubing increases longevity by reducing wear. Further, the present invention allows the weighted portion of the loop can be adjusted to the specific desires of headers, heelers, or calf ropers, which is another substantial improvement over the prior art. Further, as ropes of various colors and patterns appeal to ropers, the shrink-wrap tubing can have customized printing and graphics. Another embodiment of the invention comprises covering a portion of the lariat with a layer of natural rubber, synthetic rubber, or other elastomer.

### BRIEF DESCRIPTION OF THE DRAWINGS

A more complete understanding of the present invention may be had by reference to the following Detailed Description when taken in connection with the accompanying Drawings, wherein:

FIG. 1 is a perspective view of the invention showing the entire lariat, including the weighted portion of the tip of the loop;

FIG. 2 is a cross-sectional view of a lariat comprising a first embodiment of the invention;

FIG. 3 is a cross-sectional view of a lariat comprising a second embodiment of the invention;

FIG. 4 is a perspective view of a header mounted on horseback throwing a lariat at the horn's of a steer, and in particular showing the action or curl that is desired and which the present invention improves;

FIG. 5 is a perspective view of a heeler mounted on horseback throwing a lariat at the hind legs of a steer;

FIG. 6 is a sectional view of a lariat comprising a third embodiment of the invention;

FIG. 7 is a sectional view of a lariat comprising a fourth embodiment of the invention; and

FIG. 8 is a sectional view of a lariat comprising a fifth embodiment of the invention.

### DETAILED DESCRIPTION

Referring now to the drawings, and in particular to FIG. 1, there is shown a lariat 10 comprising a line 12 which has a honda 14 with a burner 15 at one end and a tail 16 at the other. The tail 16 extends through the honda 14 to form a loop 18, and the remainder of the line 12 is wound to form coils 20 that a user of the lariat 10 can easily hold and carry. When the lariat 10 is to be used to catch animals the user grabs the loop 18 at the portion 22 along with the spoke 24 of the line 12. The user then throws the loop 18 at the animal's head or legs in order to catch it.

A weighted portion 26 is located at the tip 28 of the loop 18. The weighted portion 26 may comprise one or more elongated, malleable metal wires of a specified length wrapped around the lariat in the grooves between the strands, and a length of shrink-wrap tubing such as neoprene that covers the length of the lariat about which the elongated metal wires are wrapped. The weighted portion 26 improves the curl or action of the tip 28 of the loop 18 as it passes over and about the neck or horns of an animal, or under the feet of an animal, which results in a higher likelihood that the animal will be caught.

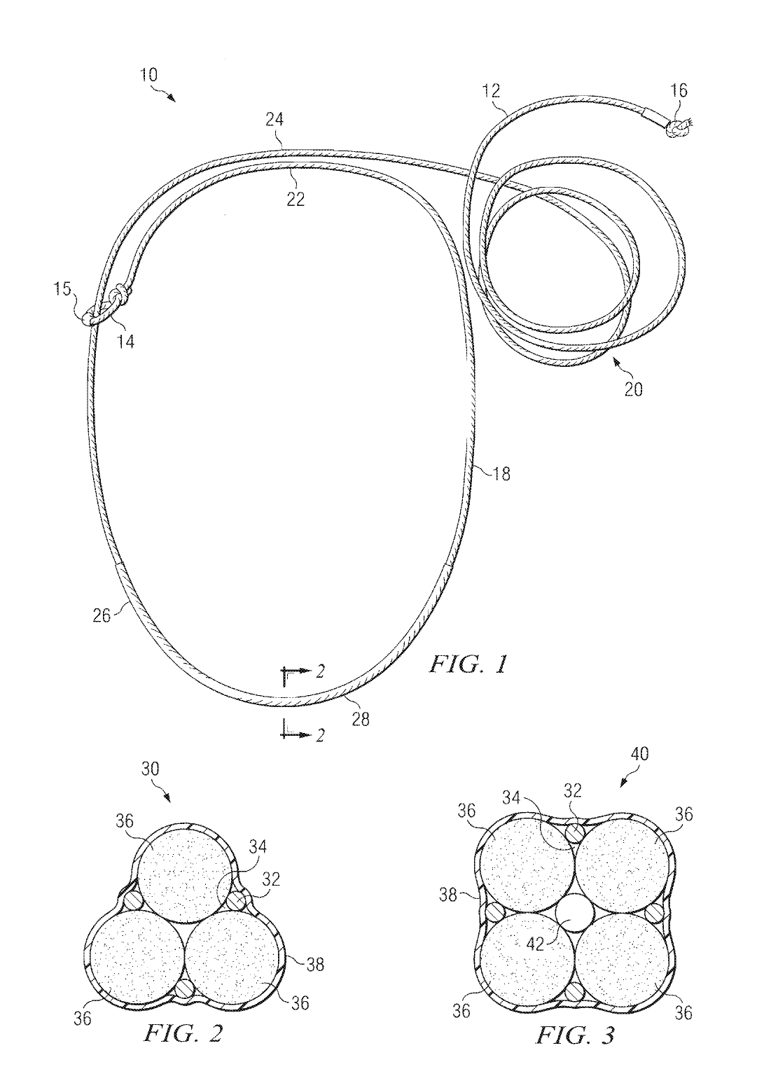

Referring to FIG. 2, there is shown a cross-sectional view of a first embodiment of the invention comprising a standard three-strand lariat 30 having an elongated metal wire 32 positioned in a groove 34 between the strands 36 comprising the three-strand lariat 30, and a length of shrink-wrap tubing 38 extending around the strands 36 and the elongated metal wire 32.

Referring to FIG. 3, there is shown a cross-sectional view of a second embodiment of the invention. A standard four-strand lariat 40 is equipped with an elongated metal wire 32 positioned in a groove 34 between the strands 36, and a length of shrink-wrap tubing 38 secured around the exterior. Also shown is a center strand 42 that is common in four-strand lariats.

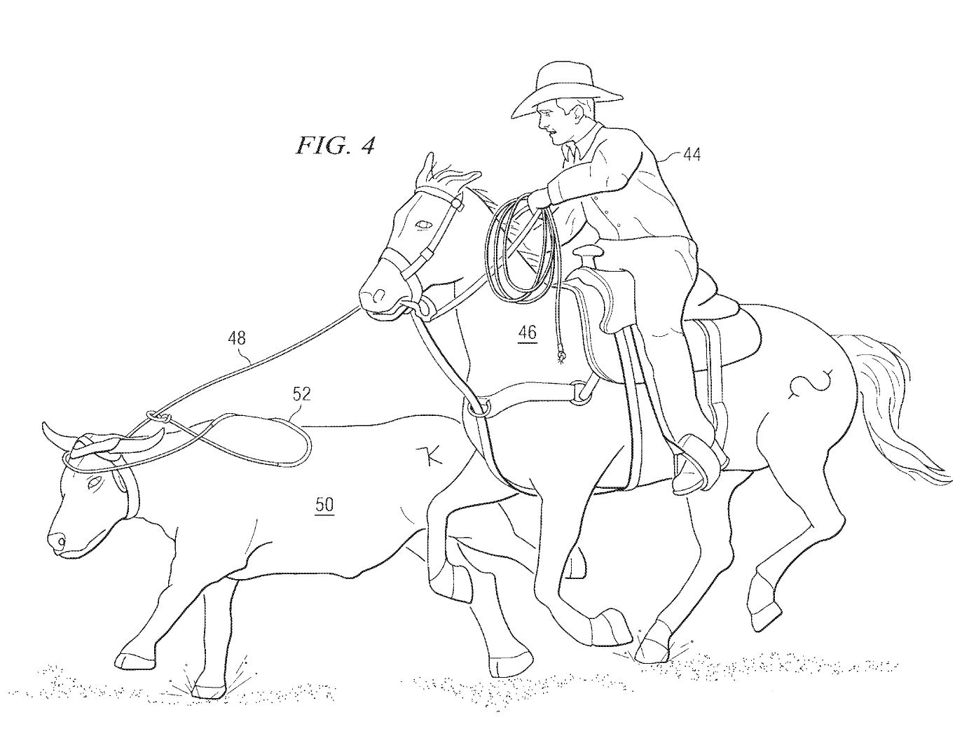

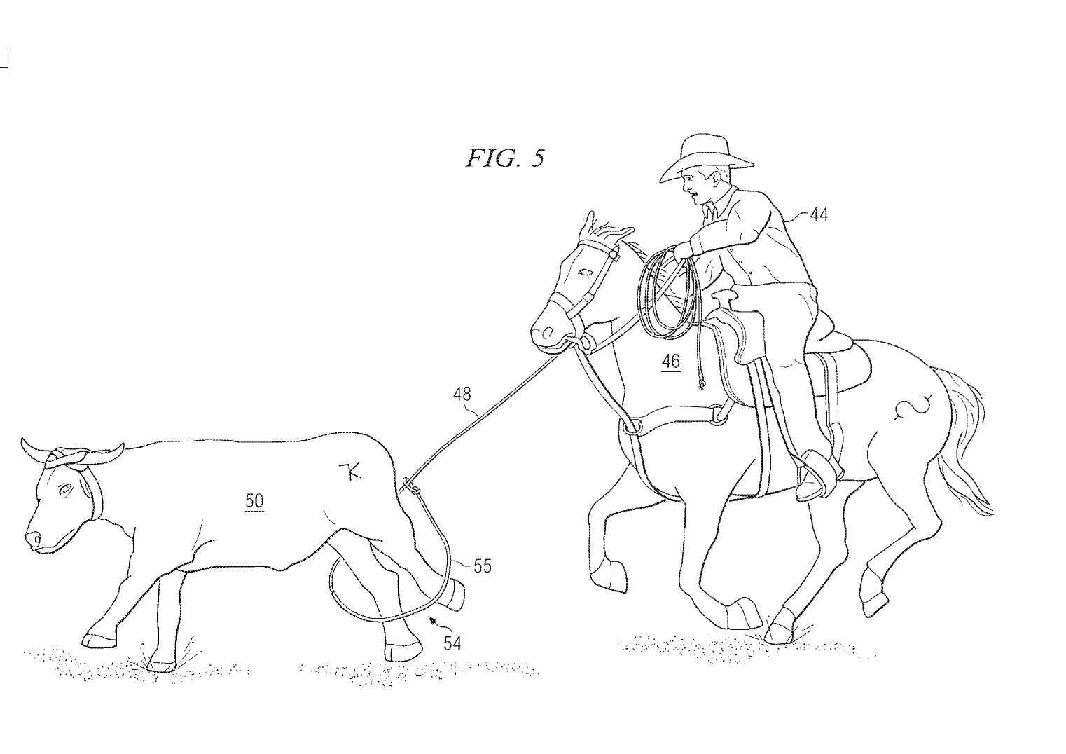

Referring to FIG. 4, there is shown a perspective view of an individual 44 mounted on horse 46 throwing a lariat 48 at a steer 50, and in particular showing the action or curl 52 that is desired and which the present invention improves. The action 52 is shown behind the steer's 40 head and neck, which is the most desirable positioning, and which is what the invention promotes. Referring to FIG. 5, there is shown a perspective view of an individual 44 mounted on a horse 46 throwing a lariat 48 at the hind legs 54 of a steer 50, and in particular snowing the follow through 55 that is desired and which the present invention improves.

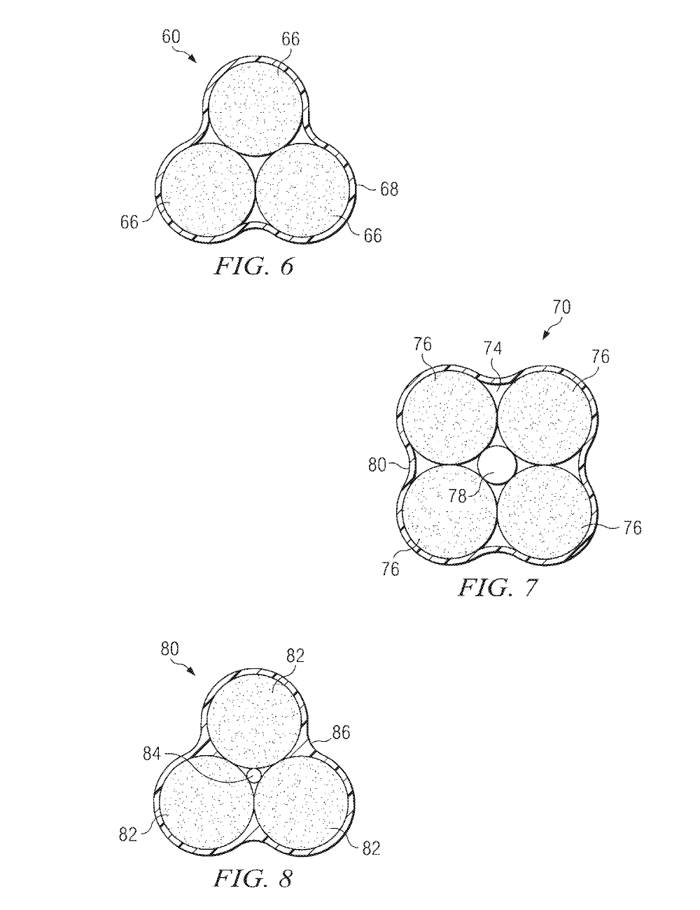

FIG. 6 illustrates a third embodiment of the invention comprising a lariat 60 that is similar in many respects to the lariat 30 of FIG. 2 but which omits the metal strands 32 thereof. The lariat 60 comprises three strands 66. A portion of the loop comprising the lariat 60 is weighted by a length of shrink-wrap material 68 which is secured tightly around the strands 66.

FIG. 7 illustrates a lariat 70 comprising the fourth embodiment of the invention which is similar to the lariat 40 of FIG. 3 but which omits the metal strands 32 thereof. The lariat 70 comprises four strands 76 and a center strand 78. A portion of the loop comprising the lariat 76 is weighted by means of a length of shrink-wrap material 80 which is secured tightly around the strands 76.

A lariat 80 comprising a fifth embodiment of the invention is illustrated in FIG. 8. The lariat 80 comprises a rope fabricated from a plurality of rope strands 82. Although three strands are illustrated in FIG. 8 those skilled in the art will appreciate the fact that the number of strands comprising the rope utilized in the fabrication of the lariat 80 depends upon the requirements of particular applications of the invention. The rope 80 may further comprise a core 84, it being understood that the core 84 may be omitted depending upon the requirements of particular applications of the invention. In accordance with the present invention the rope 80 is weighted by means of a layer 86 which surrounds the strands 82. The length of the layer 86 is similar to the length of the weighted portion 26 of the lariat 10 shown in FIG. 1. The layer 86 may comprise natural rubber, synthetic rubber or other elastomers having densities which are similar to those of natural rubber and synthetic rubber.

Although preferred embodiments of the invention have been illustrated in the accompanying Drawings and described in the foregoing Detailed Description, it will be understood that the invention is not limited to the embodiments disclosed, but is capable of numerous rearrangements, modifications, and substitutions of parts and elements without departing from the spirit of the invention.

1. A lariat comprising:
at least three elongates flexible strands twisted about one another to form a length of rope;
the strands defining grooves therebetween;
the length of rope having a honda at one end and a tail at the other end;
the tail extending through the honda to form a loop; and
a layer of a predetermined elastomer secured tightly about a predetermined section of the loop;
whereby a portion of the loop is weighted.

2. The lariat according to claim 1 wherein the predetermined elastomer comprises a natural rubber.

3. The lariat according to claim 2 wherein the predetermined elastomer comprises a synthetic rubber.

4. The lariat according to claim 2 wherein the predetermined elastomer comprises a polymeric material having a density closely matched to that of natural rubber.
